(19) United States
(12) Patent Application Publication
(10) Pub. No.: US 2004/0143613 A1
(43) Pub. Date: Jul. 22, 2004

(54) Floating point bypass register to resolve data dependencies in pipelined instruction sequences

(75) Inventors: Rainer Clemen, Boeblingen (DE); Guenter Gerwig, Simmozheim (DE); Jergen Haess, Schoenaich (DE); Harald Mielich, Stuttgart (DE); Bruce Martin Fleischer, Bedford Hills, NY (US); Eric Mark Schwarz, Gardiner, NY (US); Leon Jacob Sigal, Monsey, NY (US)

Correspondence Address: Floyd A. Gonzalez, IBM Corporation, Intellectual Property Law Department, 2455 South Road, Poughkeepsie, NY, 12601, US

(73) Assignee: International Business Machines Corporation, Armonk, NY

(21) Appl. No.: 10/752,957

(22) Filed: Jan. 7, 2004

(30) Foreign Application Priority Data
Jan. 7, 2003 (EP) 03100005.2

(51) Int. Cl. G06F 7/38

(52) U.S. Cl. 708/233

(57) ABSTRACT

A floating point unit of an in-order-processor having a register array for storing a plurality of operands, a pipeline for executing floating point instructions with a plurality of stages, each stage having a stage register, data input registers (1A, 1B, 1C) for keeping operands to be processed. The data input registers form the first stage register of the pipeline. An input port loads operands from outside said floating point unit into one of said data input registers. A plurality of bypass-registers are provided, the input of which is connected to the input port, and the output of which is provided to the data input registers (1A, 1B, 1C), such that data propagating through the pipeline to be loaded into the register array can be immediately supplied to one or more particular data input registers (1A, 1B, 1C) from a respective bypass-register without a delay caused by additional pipeline stages to be propagated through.

### BACKGROUND OF THE INVENTION

The present invention relates to the field of arithmetic processing circuits and in particular to a floating point unit of an in-order-processor.

A computer system having a floating point unit as mentioned above is basically constructed as illustrated in FIG. 1. In more detail, the Floating Point Unit specifies an operation pipeline of a floating point unit useable for example for the calculation of three operands A, B, C in a fused multiply/add-function: result=C+A*B.

The floating point unit comprises basically a register array 10 for storing a plurality of operands for the multiply/add-operation, a pipeline 8 for performing floating point instructions with a plurality of stages 1 (A, B, C) to 6, each stage having a stage register, data input registers 1A, 1B, 1C for storing operands to be processed, whereby said data input registers form the first stage register of said pipeline, and an input port 18 for loading operands from outside said floating point unit into at least one of said data input registers via a predetermined load path and a multiplexer 20.

The pipeline is shown to have a depth of 6, whereby the input registers form the first stage of the pipeline. In the second stage operand C is aligned to the already partially created product-terms of operands A and B, in the third stage the finished multiplied product is stored in respective sum- and carry-registers. Stage 4 performs the add-operation and stores the resulting sum in a respective result register of stage 4, in stage 5 the add-result is normalized and stored, and in stage 6 the result is rounded according to the IEEE 754 binary floating-point standard and then stored in the output register. Thus, every stage is provided with a respective output register which stores respective intermediate results. The results of an arithmetic operation as well as operands of a LOAD instruction appear at the end of the pipeline and may be fed back via a feedback path 35 provided for this regular case.

Assuming that the system is strictly processed as an in-order processing system, and a load instruction loads data which is accessed by a subsequent add instruction, then, the add instruction must wait until the load instruction has completed, before it may be executed. This situation is roughly depicted in FIG. 2. In the left portion of the figure a load instruction (LD (0,mem-addr)), loading contents of the given memory-address to register 0 is staging through the pipeline which can be seen from the horizontal line moving along from the left top corner to the right bottom direction. When the load instruction has stored the load operands in the respective FPR (Floating Point Registers), the subsequent add operation (ADD (2,0)) may read the operands from the input registers and may execute. Of course, it is very disadvantageous that the add instruction must wait during six cycles before starting executing.

In order to provide an access to load operands when being staged through the pipeline (to maintain serial order of completion), before they appear in the register array issued by the last pipeline stage 6, prior art technique uses a wiring back from each pipeline stage via a respective multiplexing unit to each of said operand input registers 1A, 1B, 1C. This additional feedback wiring is illustrated with reference sign 30 in FIG. 3. A plurality of three multiplexer units 32A, 32B, 32C must be additionally provided in order to enable a freely selectable access to each of the operand registers 1A, 1B, 1C. Those multiplexers are depicted with reference sign 32 A, B, C, respectively.

FIG. 4 shows the performance benefits provided by such feedback wiring for forwarding the operands for use in the following instructions in order to allow a pipelined instruction execution. As illustrated in FIG. 4, the add operation may be started before the load instruction stores operand B in the respective register as, via the back wiring fbpl and multiplexer 32 operand B may be immediately accessed by the add instruction.

As long as the number of pipeline stages is relatively small, e.g. 4 stages and address lengths of only 32 bits being used instead of 64 bits, feedback wiring 30, 32 as shown in FIG. 3 can be tolerated in most cases. Due to steadily increasing processor clock rates, however, and the resulting shorter cycles, and due to the existence of 64-bit addresses instead of 32-bit addresses, the need arises to avoid such wiring, as it leads to long signal lines, which may in turn require line amplifiers possibly even across critical areas of heavy wiring as it is the case when crossing the multiplier, for example. If for example a pipeline has 6 stages and operands are 56 bits long, then a number of 6*56=336 wires is required to be fed back to the input registers 1 A, B, C in conjunction with a respective area and delay waist due to the huge multiplexer units needed for selectively providing access to either one of the operand input registers for A, B or C, respectively.

In order to avoid such huge, critical and complex wiring the prior art U.S. Pat. No. 6,049,860, assigned to IBM Corporation, discloses to provide a wiring back not for the total of the pipeline stages, but instead, for a subtotal, for example of the second, the fourth and the sixth stage. This is not a satisfying solution to this problem, as the operands of a LOAD operation, which are passed through the pipeline together with the rest of instructions, are strongly desired to be present at any cycle at the input registers 1 before they appear at the end of the pipeline and are fed back via the regular feedback path 35.

### SUMMARY OF THE INVENTION

It is thus an objective of the present invention to provide an improved floating point unit, which is applicable for in-order processing systems and avoids the before-described wiring back of input operands from load instructions located in the various stages of a pipeline, while maintaining the principle to pass the load instructions through the whole pipeline.

According to the broadest aspect of the present invention a floating point unit of an in-order-processor is disclosed having:

a register array for storing a plurality of operands, a pipeline for performing floating point instructions with a plurality of stages, each stage having a stage register, data input registers for keeping operands to be processed, whereby said data input registers form the first stage register of said pipeline, and an input port for loading operands from outside said floating point unit into one of said data input registers, which is characterized by comprising:

a plurality of bypass-registers, the input of which is connected to said input port, and the output of which is provided to said data input registers, such that data propagating through the pipeline to be loaded into said register array can be immediately supplied to one or more particular data input register from a respective bypass-register without a delay caused by additional pipeline stages to be propagated through and passing them back from the end of the pipeline. By the term “bypass-register” set the idea to be understood is that the pipeline is bypassed for data which is stored in said register set. The data concerned is the operand data associated with a LOAD instruction.

In other words, the main goal of the present invention, to resolve the wiring congestion of the unit is achieved now within the bypass-register.

The plurality of bypass registers is advantageously operated in a FIFO (‘First In First Out’—a way of stack-organization) manner.

If the same number of bypass-registers is provided as pipeline stages are present, each individual operand from each individual pipeline stage may advantageously be fed back from the bypass-registers provided by the invention.

If further the bypass-register set is implemented as a sub-portion of the register array which is always present in a floating point unit anyway, the same multiplexer logic may be advantageously used for the register array and for the bypass-register set of this invention. This saves chip area in contrast to a solution in which the bypass-registers, provided by the present invention are implemented separately from the register array.

If further pointers are moved in the bypass-register set provided by the invention, instead of moving register contents themselves, a further contribution may be done in favor to the aim of low energy consumption.

### BRIEF DESCRIPTION OF THE DRAWINGS:

The present invention is illustrated by way of example and is not limited by the shape of the figures of the drawings in which:

FIG. 1 gives a simple prior art floating point pipeline scheme,

FIG. 2 illustrates the in-order instruction sequence with a data dependency between a load and a subsequent add instruction, according to FIG. 1,

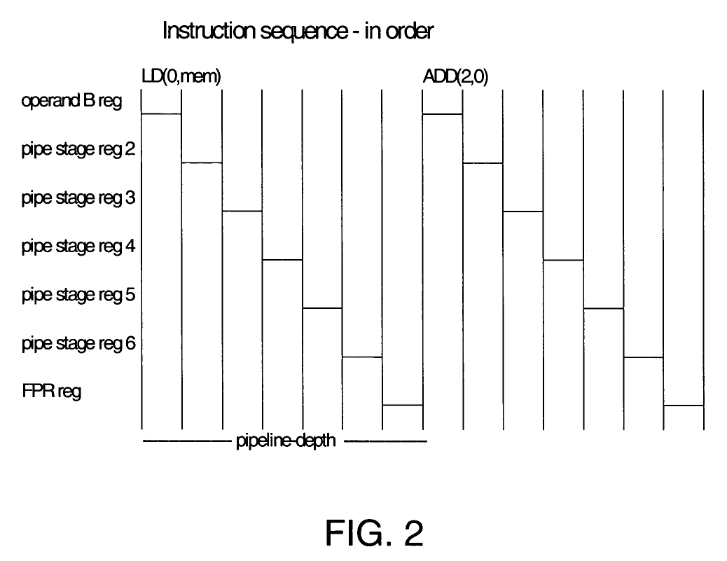

FIG. 3 illustrates a prior art solution how to resolve data dependencies without waiting until the operands appear at the end of the pipeline,

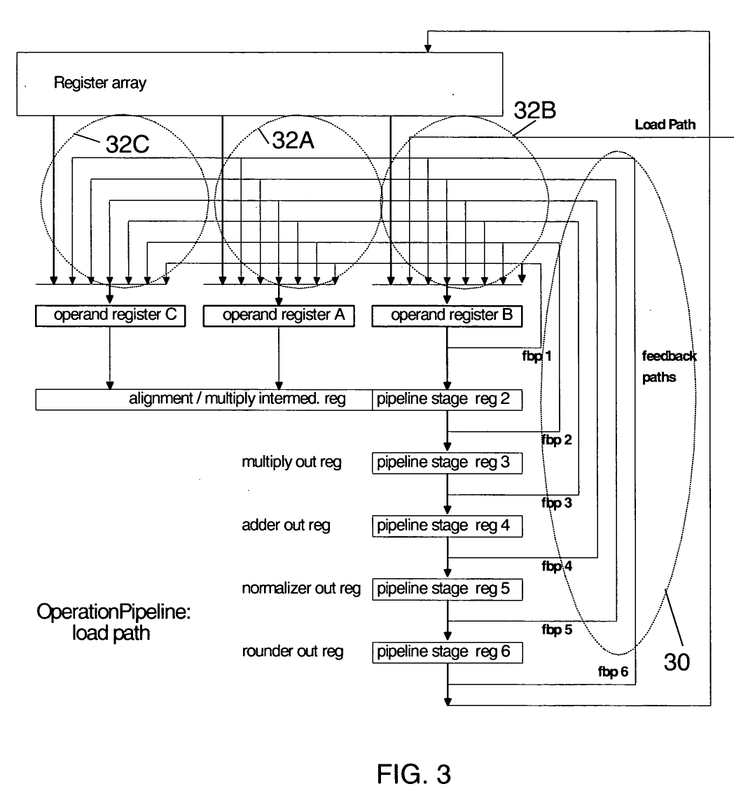

FIG. 4 is a prior art representation according to FIG. 2 reflecting the solution given in FIG. 3,

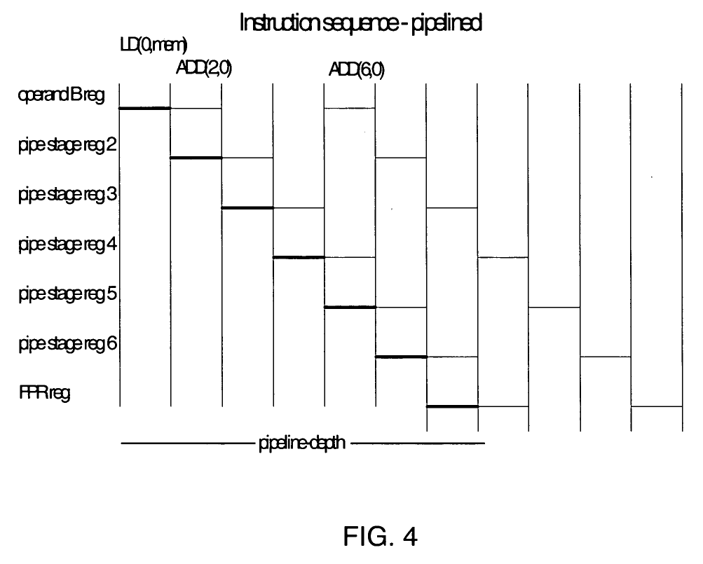

FIG. 5 illustrates a preferred solution showing the bypass-register set of the invention being included in the register array, and

FIG. 6 illustrates a further solution according to the present invention, when no integration of the bypass-register set into the floating point register array is doable.

### DETAILED DESCRIPTION OF THE PREFERRED EMBODIMENT:

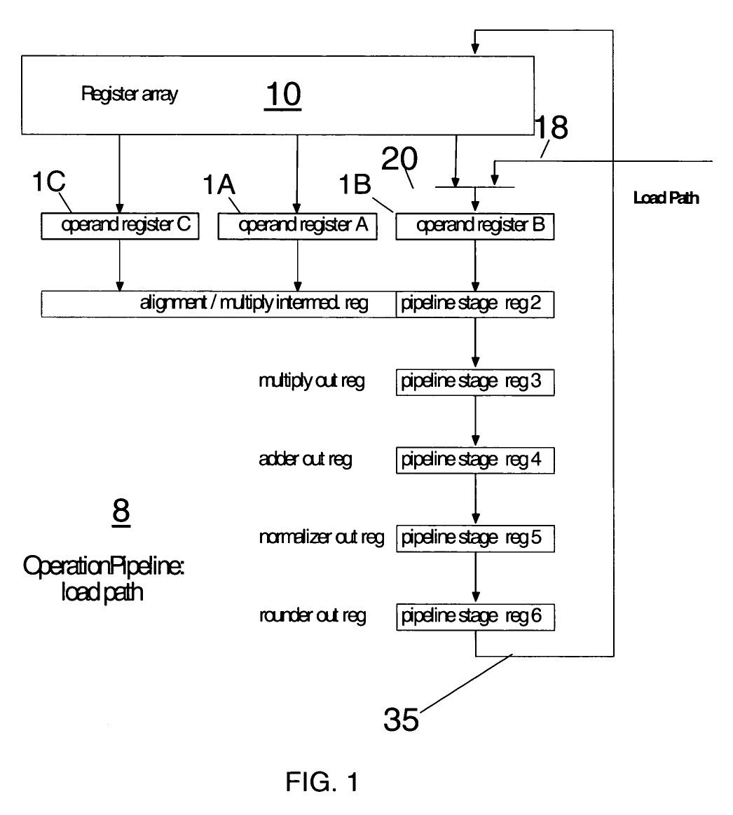

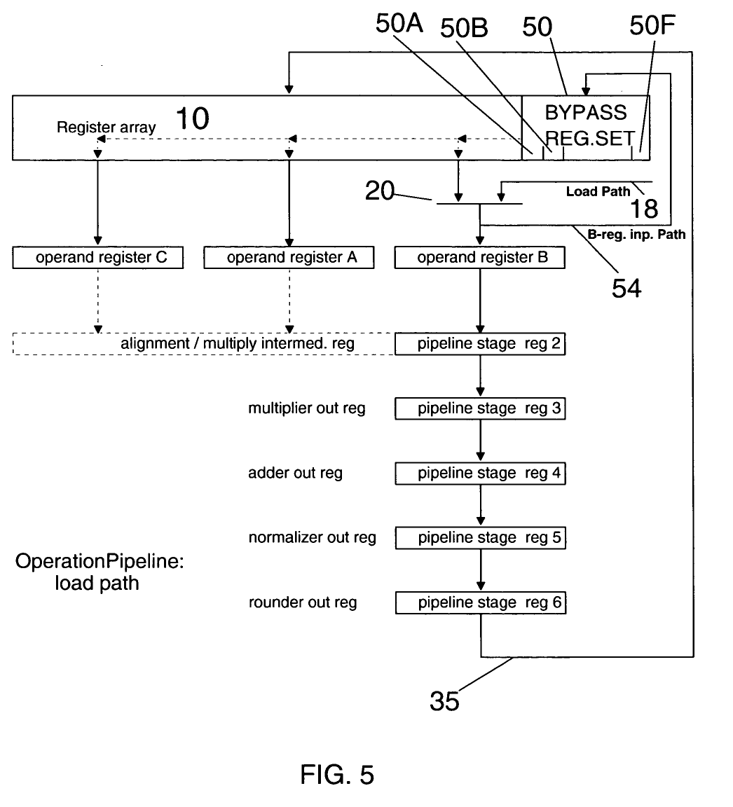

With general reference to the figures and with special reference now to FIG. 5, a preferred embodiment of the present invention is illustrated whereby additional reference is made to the description of FIG. 1, which shows the same basic structure.

According to the present invention a bypass-register set, depicted with reference sign 50 is provided as a sub-portion of the register array 10. Operand data may be stored into this bypass-register set 50 via the load path 18, which is also used in FIG. 1, and via a multiplexer unit 20 and a separate feedback line 54, which feeds the input operands coming from the load path 18 directly in the bypass-register set 50 of this invention. It should be noted that the term “bypass” is used in here in order to bypass the pipeline. Thus, the bypass-register set 50 introduced by this invention is placed at the physical entrance of the pipeline as an own part of the floating point register set. According to the present invention, this set of bypass-registers emulates in place the propagation of load-operands through the pipeline, i.e. the data is moving through the register set as it is moving through the pipeline's multiple stage registers, according to FIFO order. Thus, when load-data is needed in a following instruction the data can immediately get supplied to the entrance stage of the pipeline from the appropriate stage of the bypass-register set.

In more detail, assume a sequence of a number of ten operands is loaded via said load path 18 and the pipeline having a depth of six stages. According to a preferred embodiment of the present invention, the bypass-register set 50 comprises also a number of six registers, in order to receive operands from each of the stages. Of course, the register set may also be larger or smaller, when respective minor drawbacks can be tolerated.

Thus, in the before-mentioned sequence of ten load operands the first one is stored in register 50A, illustrated as a small compartment of the register set 50. Next cycle the second operand is stored in 50A, while the first one is moved into 50B etc., until the sixth operand is stored in register 50A. When the seventh operand comes in via multiplexer 20 and feedback line 54, this operand is stored in register 50A, while the previous one is moved into 50B, the one before into 50C and so on, until the (oldest) operand stored before in register 50F is overwritten by the operand stored before in register 50E; this is done in usual FIFO-manner.

Alternatively, also pointers to respective registers could be managed, in order to avoid moving register contents from one register to the next. When the seventh operand is stored in register 50F the first operand reappears in the register array 10 via the primary feedback line 35.

Thus, as a person skilled in the art may appreciate from the foregoing description, when load-data is needed in a following instruction, the data can immediately be supplied to the entrance stage of the pipeline from the appropriate stage of the bypass-register stack 50. For the sake of clarity, it is emphasized herewith that no results are stored in said bypass register set 50, but instead, the input operands of LOAD instructions. So the core/scope of the present invention does not relate to any subject in context of result forwarding, but relates instead to input parameter forwarding, instead of passing them solely through the pipeline. Thus, a kind bifurcation is created according to the invention, which creates a bypass way for the input operands of Load instructions at the very beginning of the pipeline.

Next, further details are given for a preferred implementation of the bypass-register set 50 provided by the present invention.

Preferably, the physical realization of bypass-register set is easily realized by a simple extension to the already existing floating point register array 10, which usually is available in any Floating Point Unit (FPU) implementation. This extension results in a tolerable addition of a few registers, e.g. 6 registers for a 6-stage pipeline, since a relatively larger number of 20 or more operand registers are present in the register array 10 anyway. The additionally required register area may be even negative (requiring eventually less area than state of the art) when the space saving is considered which is otherwise required as described above with reference to the above cited US patent, including the wiring and the input register multiplexer plus eventually necessary re-driving buffers.

As illustrated obvious from FIG. 5, by making the bypass-registers 50 a part of the Register array 10 itself, the normally used output-select mechanism 20 can be used also for the bypass-registers provided by this invention. This preferred implementation avoids the multiplexers for operand feedback required otherwise and thus avoids many costs in form of hardware and delays. Because the three read-ports of the described register array 10 are already capable of addressing all operands, the bypass-data provided by the bypass-registers of the invention can be fed into any of the 3 input-operand registers.

It should be added, that the control logic required to operate the bypass-registers 50A to 50F may be either external or be integrated into the bypass-register macro itself, whereby the latter alternative makes loading of the B-operand simpler for the control logic of the arithmetic instructions. Such control logic for operation of the bypass-registers includes stage-forwarding, the pipeline-hold mechanism, and may also contain the operand-compare for the next instruction, required to decide where this operand has to be taken from.

As should reveal from the above description, the present invention comprises the use of a stack of registers according to the pipeline depth instead of wiring back the data from their actual position within the pipeline. Thus, the operand data required to be forwarded can be taken by selecting the appropriate bypass-register instead of waiting for the data to finish their way through the long pipeline or getting wired back through additional wires as it is done in prior art. This basic principle of the invention avoids the plurality of wires coming back from all over the pipeline. Thus, a considerable saving of wiring is achieved, in particular n-times (m-1) wires, where n is the bit-width of the data-flow and m is the number of pipeline stages. As a person skilled in the art may appreciate, with the additional saving of wire-buffers, area and wiring length, an additional advantage of a faster cycle time can be achieved according to the present invention.

In the preferred form the bypass-registers are FIFO-stack-structured: the data coming in from the load-path 18 is shifted through the bypass-register-stack, one stage per pipeline-step. Data is lost register-wise after the last stage. The shift-progress can be controlled from the external control-logic, too. Thus, in case of a pipeline-stall, the bypass-register set can be stopped simultaneously to the pipeline-registers themselves, in order to guarantee that the bypass-register stack stays in-sync with the pipeline itself.

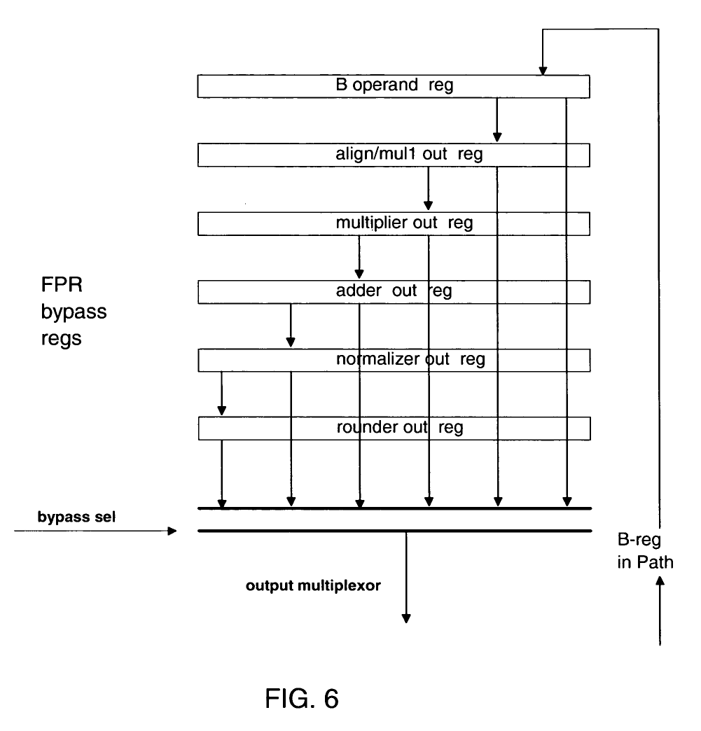

A further variation of the inventive concept is illustrated with additional reference to FIG. 6, which shows an alternative realization of a bypass register set as introduced with our invention, if no integration into the FPU register array 10 itself is doable or desired due to any other reason.

For example, an alternative realization of the bypass register set, referred to also as bypass-stack may be provided as a single stack logic having an own output multiplexer and a bypass-select signal is provided from the control logic in order to select either of the register contents and multiplex it to the required operand input register A, B, or C.

FIG. 6 shows that the bypass-register set can also be implemented independent of the FPU register array 10 as a standalone design.

Thus, the bypass-register set does not need to be addressed and read like an array, but could also be built by a group of registers, typically organized like a stack or FIFO, with the load-path as input to this stack and e.g. a multiplexer or other suited means to select/address the required register according to the pipeline stage that should get load-forwarding data. To allow forwarding up to all 3 operands of a 3 operand dataflow, up to 3 output select mechanisms could be applied. To save hardware, a subset of this full-blown mechanism approach could be chosen, with the impact to restrict forwarding-paths and such the performance, and with the side effect of making forwarding-control more complex, needing to skip unavailable paths.

Furthermore, it should be noted that the present invention's basic concept is not limited to the multiply/add pipeline which was taken solely as an example. However, it is applicable to any pipeline independent of the actual use thereof. The benefit achievable by the present invention is the larger, the deeper the pipeline is.

Moreover, the principle of this invention may be varied to comprise also modifications in which the feedback line 54 starts from a different point associated with the top portion of the pipeline, for example after stage 1, stage 2, or stage 3 in the 6-stages pipeline example depicted FIG. 5. Of course, the advantage of shorter propagation time decreases with higher stages starting points.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A floating point unit of an in-order-processor comprising:
a register array for storing a plurality of operands;
a pipeline for performing floating point instructions with a plurality of stages, each stage having a stage register;
data input registers for keeping operands to be processed, whereby said data input registers form the first stage register of said pipeline;
an input port for loading operands from outside said floating point unit into one of said data input registers; and
a bypass having an input connected to said input port, and an output connected to said data input registers.

2. A floating point unit according to claim 1, wherein said bypass is a plurality of bypass registers.

3. A floating point unit according to claim 2 wherein each pipeline stage is connected to a bypass-register.

3. The floating point unit according to claim 2 wherein said bypass registers are a portion of said register array.

4. The floating point unit according to claim 2, wherein the bypass-registers are operated in a FIFO manner.

5. The floating point unit according to claim 1, further comprising a set of pointers each pointing to a respective register.

6. A processor chip comprising:
a register array for storing a plurality of operands;
a pipeline for performing floating point instructions with a plurality of stages, each stage having a stage register;
data input registers for keeping operands to be processed, whereby said data input registers form the first stage register of said pipeline;
an input port for loading operands from outside said floating point unit into one of said data input registers; and
a plurality of bypass-registers, each bypass-register having an input connected to said input port, and an output connected to one of said data input registers.
